(19) United States
(12) Patent Application Publication
(10) Pub. No.: US 2016/0154434 A1
(43) Pub. Date: Jun. 2, 2016

(54) SLIDABLE DISPLAY APPARATUS

(71) Applicant: Muizz Lakhani, Carrollton, TX (US)

(72) Inventor: Muizz Lakhani, Carrollton, TX (US)

(21) Appl. No.: 14/956,008

(22) Filed: Dec. 1, 2015

Related U.S. Application Data
(60) Provisional application No. 62/086,104, filed on Dec. 1, 2014.

(51) Int. Cl. G06F 1/16

(52) U.S. Cl. CPC G06F 1/1647; G06F 1/1616

(57) ABSTRACT

The present invention includes a method and an apparatus for adding an external display to an electronic device, the apparatus comprising a first panel with a slidable display device, a display manager to enable the electronic device to control the slidable display device, and a power supply to power the slidable display device. The method for adding an external display comprises engaging an electronic device to the apparatus with the slidable display device, positioning the slidable display device to a desired position, and initiating the display manager to connect the slidable display device to the engaged electronic device.

### CROSS-REFERENCE TO RELATED APPLICATIONS

This Non-Provisional Patent Application claims priority to U.S. Provisional Patent Application Ser. No. 62/086,104, filed Dec. 1, 2014, entitled “SLIDABLE DISPLAY APPARATUS”, the contents of which is incorporated by reference herein in its entirety.

### TECHNICAL FIELD OF THE INVENTION

The present invention relates in general to the field of attachable accessories for portable electronic devices, and more particularly, to an accessory that adds a slidable display to an electronic device.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with laptops and multiple monitor displays.

U.S. Pat. No. 6,859,219 issued to Sall teaches a display apparatus that includes a primary display device for a computer. The patent also teaches that the display apparatus also includes at least one secondary display device for the computer with the at least one secondary display device being operatively coupled to the primary display device. The at least one secondary display device is stored in a housing behind the primary display device, such that the at least one secondary display device can be extended from the housing and used to display information for the computer. The secondary display device of display apparatus taught by the patent is unitary with the primary display device and not removable. The invention is not an attachable accessory to an electronic device. The secondary display device also lacks an independent power source.

U.S. Pat. No. 6,532,146 issued to Duquette teaches a display apparatus comprised of a device enclosure supporting a front panel and a monitor housing supporting a first monitor screen. The monitor housing is pivotally engaged with the device enclosure, and enabled for pivotal movement between a closed position wherein the first monitor screen is approximately parallel to the front panel, and an open position, placing the first monitor screen at an angle to the front panel.

A sliding assembly supports plural further monitor screens. The further monitor screens are enabled for sliding movement between concealed positions within the monitor housing and viewing positions lateral to the monitor housing.

U.S. Pat. No. 7,136,282 issued to Rebeske teaches a laptop computer constructed to have a case including a keyboard and containing traditional computer components. A display screen is pivoted about the hinge to an operative position wherein an operator can observe the information displayed on the screen. The patent also teaches a second display screen pivotally secured to the first display screen and is also connected to the computer components within the computer case. The second display screen, when hinged to its operative position displays the same information displayed on the first display screen, but is directed to an opposite direction to permit an operator and an observe to observe the same information viewable on the first and second display screens, respectively.

U.S. Patent Application Publication No. 2003/0218577 issued to Wang teaches a laptop computer having three screens extending upward from a computer base for providing a large combined display area, wherein the three screens can be stacked in a compact manner for portable storage. The patent teaches a laptop computer which includes a computer base, and a center screen rotatably connected to the top of the computer base. The patent also teaches a left and right pole that are rotatably connected to the top of the computer base on opposite sides of the center screen. A left and right screen are rotatably connected to the left and right pole, respectively. In an operative mode, the center, left and right screen are rotated to extend upward from the computer base to provide a large combined display area. In a storage mode, the center, left and right screen are rotated to be stacked above the computer base to provide compact storage and east transport of the laptop computer.

U.S. Patent Application Publication No. 2004/0264126 issued to Wells teaches a universal laptop case. The case is in three main parts: the top, upper lid, the middle, inner cover, and bottom housing. The removable upper lid houses the display screen on the inside and the solar cells on the back of the lid. The slim, narrow, middle inner unit holds the speakers, mouse pads, keyboards, LDC readout, small display screen, motherboards, expansion cards, and controller cards. It is detachable from the top or bottom section of the case forming a diversified case. The bottom of the case has the physical, drawer like, expandable, slidable ends to the right and left of the front of the case and knockout panels, which are for mounting the face of the peripherals. The patent teaches that the case will be composed of a top lid and either/or middle or bottom section, forming a complete computer housing.

U.S. Patent Application Publication No. 2005/0137942 issued to LaFleur teaches a portable information kiosk. The kiosk has a self contained power supply for a computer, a display, a digital camera, a cellular, satellite capable telephone, an antenna, a printer and a flat bed scanner, all electrically connected to each other and capable of being stored in a small carrying a case. The patent teaches the kiosk as being ideal for in the field communications and data acquisition such as in disasters, emergencies, or any in the field environmental monitoring.

U.S. Patent Application Publication No. 2006/0247798 issued to Scott teaches a display for use in, for example, small electronic devices such as notebook computers. The display of the invention has a main display panel and an auxiliary display panel, wherein the auxiliary display panel is slidably mounted in a housing behind the main display panel when not in use. The auxillary display panels claimed by the application are unitary with the main display panel. The auxillary display panels are also not removable and lack an independent power supply.

U.S. Patent Application Publication No. 2006/0082518 issued to Ram teaches a multiple monitor display apparatus in the form of a laptop PC, a desktop monitor, a mobile device, and the like. In dual screen mode, the additional monitor is typically presented displaying different content and centered to the user. In single screen mode, the additional display enclosures are retracted and stored in such a manner that they do not present themselves to the user. The patent teaches a guiderail assembly that is used to center both display enclosures relative to the user. The secondary enclosure may be extended and retracted from the primary enclosure by the use of slider arms. The secondary enclosure may also be hinged to the primary enclosure, utilize pegs, ride on its own guiderail, and detach from the primary enclosure or the apparatus.

U.S. Patent Application Publication No. 2007/0285343 issued to Han et al. teaches a dual-screen mobile display for a mobile device which includes an image signal supply part for supply a first image signal and a second image signal. A first active matrix organic light emitting display panel displays the first image signal. A housing mounts the first active matrix organic light emitting display panel. A second active matrix organic light emitting display panel is adapted to be inserted in and pulled out from the housing and displays at least one of the first image signal or the second image signal. The patent also teaches a moving mechanism that moves the second active matrix organic light emitting display panel outside of the housing. The publication however teaches the second active matrix organic light emitting display panel as being unitary with the first display panel instead of a separable add-on device. The second display panel also lacks an independent power supply.

U.S. Patent Application Publication No. 2009/0201222 issued to Damian teaches an affordable, integrated multiple monitor system for desktop computers, laptops, television sets, other standalone or mobile telecommunication or personal electronic devices (PDA, GPS, cellular phones, cameras, camcorders, MP3/MPEG, etc).

U.S. Patent Application Publication No. 2011/0298690 issued to Reilly teaches a multiple display device having a main display screen and a display housing. The application also teaches that the display device also comprises of a plurality of extended display screens varying in sizes that can be pulled from a plurality of screen slots peripherally positioned about the display housing. The extended display screens claimed by the application are unitary with the main display screen, not removable, and lack an independent power supply.

U.S. Patent Application Publication No. 2011/0247249 issued to Cao teaches a double display structure that includes both a first display and a second display; as well as a sliding member. The sliding member slidably mounts the first display on a second display. The sliding member includes a guiding portion and a slide interchangeable mounted on the first display and the second the display.

U.S. Patent Application Publication No. 2013/0021734 issued to Singhal teaches a portable computing and communication device that has a main display screen and an additional display screen attached to the backside of the device body, wherein the backside stores and hides the additional display screen when not in use. The application claims a portable computing and communication device wherein the main display and additional display screen are unitary in a single device. The additional display screen also lacks an independent power source.

U.S. Patent Application Publication No. 2013/0311889 issued to Pedersen teaches an apparatus, system, and method for presenting images in a multiple display environment. The patent teaches an invention that includes a computer-readable medium with instructions for receiving from a primary user, a selected portion from a primary screen, where the selected portion is one of an image and a portion of a program. The selected portion is then displayed on one or more secondary screens. The patent also discloses a multiscreen laptop computer ideally suited for multi-screen presentations, and a dual-monitor display device which can be easily connected to a computer to facilitate multi-screen presentations.

### SUMMARY OF THE INVENTION

In one embodiment, the present invention is an apparatus comprising: a first panel configured to releasably engage an electronic device wherein the first panel further comprises a slidable display device, a display manager adapted to enable the electronic device to control the slidable display device, and a power supply to power the slidable display device. In another embodiment wherein the electronic device has a first surface and a second surface, the apparatus further comprises a second panel, wherein the second panel is configured to releasably engage the second surface of the electronic device. In one aspect wherein the first panel further comprises a first side, a second side, a third side, and a fourth side, the slidable display device slides out of at least one of the first side, second side, third side, or fourth side of the first panel. In another embodiment wherein the first panel further comprises additional slidable display devices, at least two of the slidable display devices slide out of at least one of the first side, second side, third side, or fourth side of the first panel. In another aspect of the apparatus wherein the first panel comprises additional slidable display devices, each additional slidable display device may include one or more additional video cards.

In another embodiment, the electronic device is further defined as comprising an electronic device display. The display manager is adapted to enable the electronic device to control the slidable display device independently of the activity or inactivity of the electronic device display. In one aspect, the first panel may fully enclose the slidable display device when not extended. In another aspect, the first panel further comprises at least one hinge between the first panel and the slidable display device to enable the rotation of the slidable display device when extended. In another embodiment, the positioning or the sliding of the slidable display device may also be motorized.

In another aspect, the display manager may connect the electronic device to the slidable display device either physically or wirelessly. The display manager may be integral with at least one of the first panel, a second panel, or the electronic device, or be independent from the first panel, the second panel, and the electronic device. Likewise, the power supply may also be integral with the first panel, a second panel, or the electronic device. The power supply may also be independent from the first panel, the second panel, and the electronic device.

Other embodiments of the present invention also include a case with a sliding display comprising: a first panel configured with a second panel to hold an electronic device wherein the first panel further comprises a slidable display device, a display manager adapted to enable the electronic device to control the slidable display device, and a power supply to power the slidable display device. In one aspect, the first panel and the second panel of the case may be connected with a hinge. The first panel and the second panel may also be directly connected. The display manager may wirelessly connect the electronic device to the slidable display device. The display manager may also be integral with at least one of the first panel, second panel, or the electronic device, or be independent from the first panel, second panel, and electronic device. The power supply may be integral with at least one of the first panel, second panel, or the electronic device, or be independent from the first panel, second panel, and electronic device.

The present invention also includes a method for adding an external display to an electronic device comprising: engaging an electronic device to a slidable display apparatus with the slidable display apparatus comprising a first panel configured to releasably engage the electronic device wherein the first panel further comprises a slidable display device, a display manager adapted to enable control over the slidable display device using the engaged electronic device, and a power supply to power the slidable display device. The method also further comprises positioning the slidable display device to a desired position, and initiating the display manager to connect the slidable display device to the engaged electronic device.

In one embodiment wherein the electronic device has a first surface and a second surface and the slidable display apparatus further comprises a second panel configured to releasable engage the second surface of the electronic device, the method also includes engaging the second panel of the slidable display apparatus to the second surface of the electronic device. In another aspect wherein the first panel further comprises a first side, a second side, a third side, and a fourth side, the method further comprises sliding the slidable display from at least one of the first side, second, side, third side, or fourth side of the first panel. In another aspect where the apparatus has an additional slidable display apparatus, the method includes positioning at least two slidable display devices. More than one slidable display device may slide out of the same side of the first panel. A single slidable display device may also be capable of sliding out of more than one side of the first panel to provide user flexibility. The initiating of the display manager to connect the slidable display device to the engaged electronic device may include physically connecting an adapter from the display manager in the apparatus to the electronic device, or wirelessly connecting the apparatus to the electronic device.

The present invention also includes a method of making an apparatus that adds an external display to an electronic device comprising: obtaining a first panel configured to releasably engage an electronic device, attaching a slidable display device to the first panel, integrating a display manager with the apparatus to enable the electronic device to control the slidable display device, and integrating a power supply with the apparatus to power the slidable display device. Wherein the electronic device has a first surface and a second surface, the method also includes obtaining a second panel configured to releasably engage the second surface of the electronic device. In one aspect, the method may include connecting the first panel and the second panel. The method may also include attaching additional slidable display devices to the first panel. Wherein the additional slidable display devices are used, the method may further comprise connecting one or more video cards to the apparatus for each additional slidable display device attached.

### BRIEF DESCRIPTION OF THE DRAWINGS

For a more complete understanding of the features and advantages of the present invention, reference is now made to the detailed description of the invention along with the accompanying figures and in which:

FIG. 1 is a side view of an electronic device being engaged to the first panel of the slidable display apparatus.

FIG. 2 illustrates the first panel and the second panel of the slidable display apparatus engaged to an electronic device.

FIG. 3 illustrates the apparatus engaged to the first panel and second panel of an electronic device with the slidable display extended.

FIG. 4 illustrates the first panel and second panel of the apparatus engaged to an electronic device with the electronic device in the closed position.

FIG. 5 shows the apparatus engaged to the electronic device as the electronic device is being closed.

FIG. 6 is an internal view of the apparatus illustrating an example of the power supply and display manager.

FIG. 7 illustrates examples of different placements of rails when attached behind the slidable display.

FIG. 8 illustrates examples of different rails that can be used when positioning the slidable display.

FIG. 9 illustrates another embodiment of the apparatus as an electronic device case with a slidable display.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention includes an apparatus for adding an external display to an electronic device while providing a layer of protection to unused surfaces of the electronic device. The apparatus includes a first panel configured to releasably engage an electronic device such as but not limited to a laptop, tablet, tablet computer, cell phone, smart phone, reader, MP3 player, camera, video camera, televisions, gaming system, external hard drives and the like. The apparatus can also attach to display screens, desktop computers, gaming systems, all-in-one devices, projectors, or another apparatus of the present invention. The first panel can engage the electronic device by mechanical or other attachment including but not limited to clips, hinges, snap on clips, spring clips, hook and loop (e.g., VELCRO®), magnetic, adhesive, double sided adhesive, electrostatic, and the like. For electronic devices that have more than one unused surface such as a laptop that can benefit from another layer of protection without hindering the use of the device, the apparatus includes a second panel also configured to releasably engage and protect the additional second surface. The apparatus can also include a gyroscope or equivalent device that provides the user with an orientation (up or down), such that the display can automatically adjust if positioned on a right or left side of an electronic device. The apparatus can also include an arm or other mechanism to attach to a stand of a display or all-in-one device, or to the display device itself.

The first panel includes a slidable display device that can be positioned to add an external display to the electronic device. The slidable display device may slide out from any side of the enclosing panel. The slidable display may be a tablet or tablet computer, and may even detach from the first panel. The slidable display device adds an external display that includes but is not limited to a liquid crystal display (LCD), light emitting diode (LED), surface-conduction electron-emitter display (SED), field emission display (FED), electron paper display (EPD), plasma display panel (PDP), digital light (IMOD), eInk, SiPix, cathode ray tube (CRT), Lenticular, active-matrix organic light-emitting diode (AMOLED), in-plane switching LCD (IPS LCD), thin-film-transistor LCD (TFT LCD), and twisted nematic LCD (TN LCD).

The apparatus of the present invention provides an accessory to an electronic device that adds a layer of protection to some surfaces of the electronic device as well as an external monitor. The slidable display device would be useful in giving the user either additional display space to navigate, or provide the user with an initial display on the go to view contents of the electronic device. Using the apparatus to provide an initial display would be advantageous for electronic devices that usually require connection to a separate display for the contents to be viewed such as a digital camera or a hard drive.

In another embodiment, the first panel may also include more than one slidable display device where more than one of the slidable display devices may slide out of the same side of the first panel. Additional slidable display devices may also slide out of different sides of the first panel. In another embodiment, the slidable display device may slide out of more than one side of the first panel giving the user flexibility in where the external display is desired. In another aspect, the apparatus may include one or more additional video cards for each additional slidable display device included in the apparatus. When the slidable display device is hinged, the hinge may lock when fully extended, and may further include a lock at the end of the slide or rail.

In another embodiment, the first panel may act as a housing of the slidable display device and completely enclose the slidable display device when the slidable display device is not extended for use. It is also possible that the first panel only partially encloses the slidable display device to begin with regardless if the slidable display device is extended or not. In another aspect, the positioning or sliding of the slidable display device may be motorized. In another embodiment, guiding rails are attached to the back of the slidable display device to guide the positioning of the slidable display device by sliding in and out of corresponding cutouts in the first panel.

The apparatus can be made from but is not limited to plastic, foamed plastic, wood, cardboard, pressed paper, metal, supple natural or synthetic materials including, but not limited to: cotton, elastomers, polyester, polymer, rubber, derivatives thereof, and combinations thereof.

Suitable metals may include stainless steel, titanium, iron, iron alloys, metal, nickel, steel, steel alloy, stainless steel alloys, aluminum, aluminum alloys, bronze alloys, brass, brass alloys, chromium, copper, copper alloys or the like. Suitable plastics may include polymers, polyester epoxy, reinforced plastics, fiberglass, high-density polyethylene (HDPE), low-density polyethylene (LDPE), polystyrene, high impact polystyrene, acrylonitrile butadiene styrene (ABS), polyvinylidene chloride (PVC), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

The apparatus also includes a display manager that enables the electronic device to connect and control the external slidable display device. The display manager may include but is not limited to connecting the electronic device and slidable display device using composite video, Syndicat des Constructeurs d'Appareils Radiorécepteurs et Téléviseurs (SCART), S-Video, color graphics adapter (CGA), monochrome display adapter (MDA), Hercules graphics card (HGC), enhanced graphics adapter (EGA), Amiga Video, video graphics array (VGA), mini-VGA, Mac-II/Quadra, 13W3, GVIF, OpenLDI, Component Video, digital visual intervace (DVI), mini-DVIA, serial digital interface (SDI), high definition multimedia interface (HDMI), DisplayPort, digital interface for video and audio (DiiVa), HDBaseT, IEEE 1394, BNC, CoaXPress, DB13W3, D Terminal, DMS-59, and Musa.

The display manager may also connect the electronic device to the slidable display device wirelessly using but not limited to Wi-Fi, 802.11ac wireless, DLNA, Bluetooth, NFC, Wi-Fi Certified Miracast, or the like. The display manager may be integral with at least one of the first panel, second panel, or electronic device. The display manager may also be independent and separate from the first panel, second panel, or electronic device. In another embodiment where the electronic device has an inherent electronic device display, the display manager may be configured to also enable the electronic device to control the slidable display device independently of the activity or inactivity of any inherent electronic device display. This includes when the user does not have a desire to use or activate the inherent electronic device display, or the inherent electronic device display is no longer functional, which is one of the advantages of the present invention. In addition to adding an external display to an electronic device, the apparatus could be used as a replacement display in the instance the inherent electronic device display is broken.

When connected to the electronic device by the display manager, the slidable display apparatus may be configured to a variety of display preferences depending on the desire of the user and the electronic device. If the electronic device has an inherent electronic device display, the slidable display device may be configured in as an extended display, or a mirror of inherent electronic device display. For electronic devices without an inherent electronic device display, the slidable display device may be used as a primary display to display contents or media of the electronic device.

In another aspect, the power supply that powers the slidable display apparatus may be integral with the first panel, the second panel, if present, or the electronic device. The power supply may also be independent and separate from the first panel, the second panel, and the electronic device. Non-limiting examples of a power supply for the apparatus includes electrical energy transmission systems, energy storage devices, batteries, lithium batteries, alkaline batteries, lead-acid battery, lithium-ion batteries, nickel-cadmium batteries, nickel-iron batteries, nickel-zinc batteries, nickel-metal hydride batteries, rechargeable alkaline batteries, rechargeable fuel batteries, fuel cells, electromechanical systems, generators, alternators, and solar power converters. As used herein, the term “power supply” also refers to a power source. The apparatus may be configured to power the slidable display apparatus through a fixed power source including but not limited to DC power supply, AC-to-DC power supply, AC power supply, and switched-mode power supply. In one non-limiting example, the power source can be on the electronic device, can charge the power supply internal to the apparatus, or can toggle between the two power supplies, which change can be automatic or via a switch. The power supply of the electronic device can also be used to charge a power supply internal to the apparatus.

Another embodiment of the present invention includes a case with a sliding display. The case is comprised of a first panel configured with a second panel to hold an electronic device. The first panel includes a slidable display device for adding an external display. The case also has a display manager adapted to enable the electronic device to control the slidable display device and a power supply to power the slidable display device. In one aspect, the first panel and the second panel of the case are connected by a connecting piece such as but not limited to a hinge or joint. In another embodiment, the first panel and second panel may be directly connected without a connecting piece. In another aspect, the slidable display device may slide out of side of the first panel. In another aspect, the case may also have more than one slidable display device with more than one slidable display device sliding out of the same side of the panel. The case may also have a single slidable display device capable of sliding out of multiple sides of the first panel. In another aspect, the case may also include at least one or more additional video cards for each additional slidable display device. The advantage of this embodiment of the apparatus is to slide out a display of the case holding the electronic device for quick display of contents or presentation without having to take out the electronic device or set up. The case with a slidable display also allows the user to slide out a display for self viewing of contents on the electronic device without having to take out the entire electronic device. This would be useful when the user is traveling where taking out the electronic device may be inconvenient or put the device at risk of being dropped or damaged.

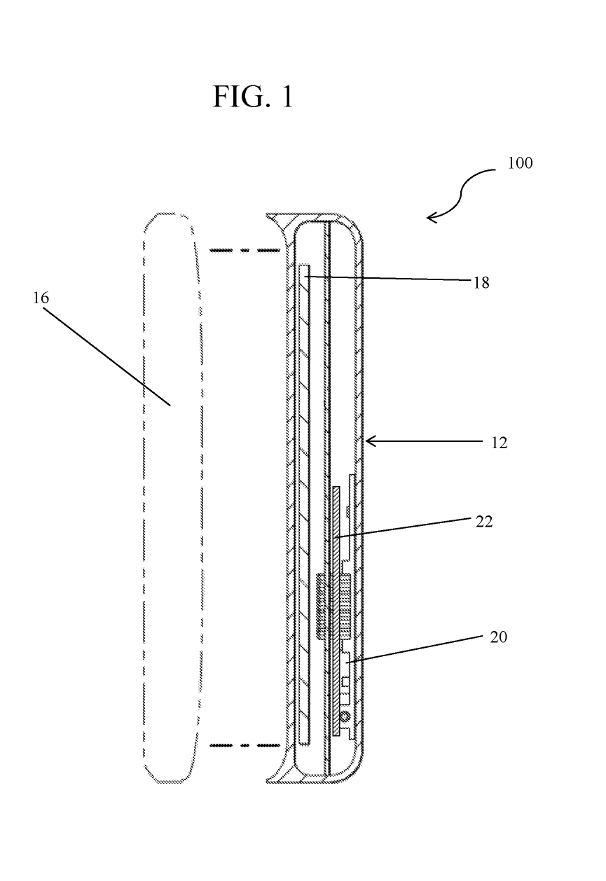

FIG. 1 depicts the side view of a single surface electronic device 16 being releasably engaged to first panel 12 of apparatus 100. First panel 12 of apparatus 100 contains slidable display device 18 powered by power supply 22. Single surface electronic device 16 will be able to control slidable display device 22 using display manager 20. First panel 12 also provides a layer of protection over the back of electronic device 16 that is getting covered by first panel 12.

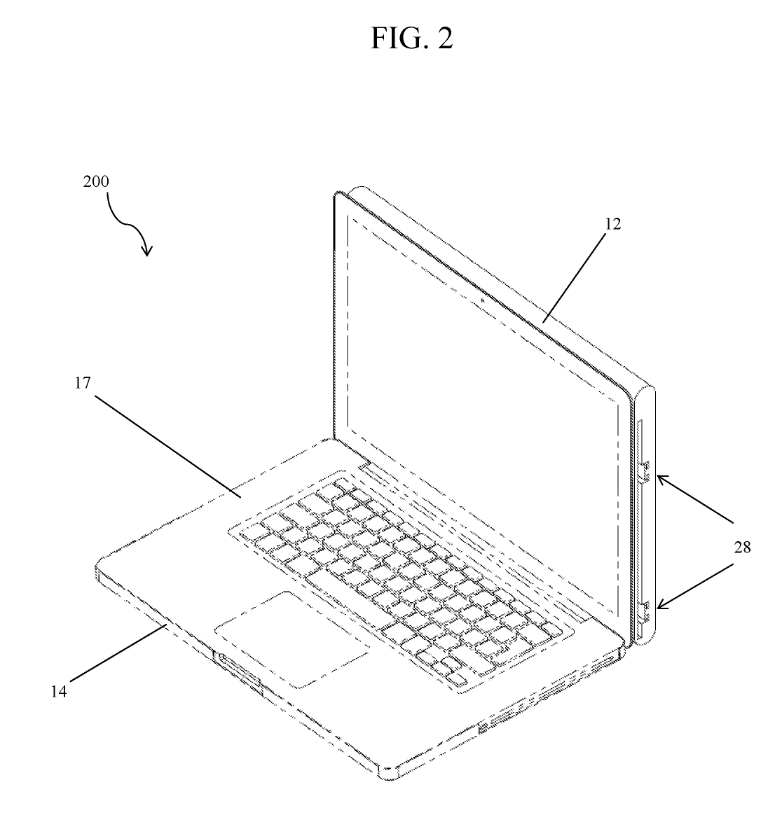

FIG. 2 depicts a perspective view of a multi-surface electronic device 17 engaged to a first panel 12 and second panel 14 of apparatus 200. First panel 12 provides protection for the top cover of electronic device 17. Second panel 14 provides protection for the bottom base of electronic device 17. FIG. 2 also depicts guide rail cutouts 28 in first panel 12 that show where the slidable display device will slide out of.

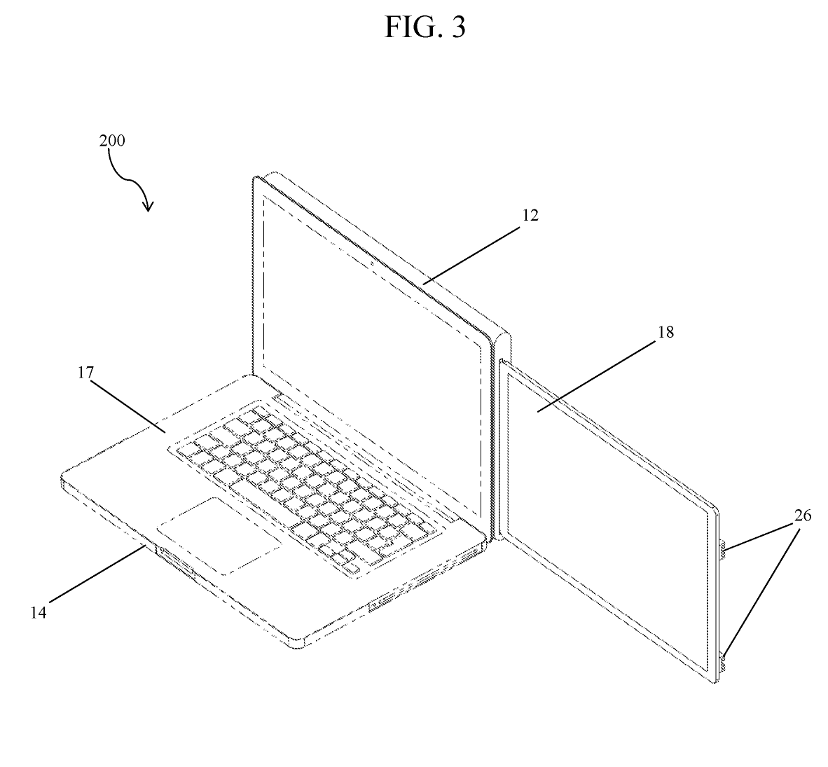

FIG. 3 depicts apparatus 200 with slidable display device 18 extended out of first panel 12. First panel 12 and second panel 14 are engaged to electronic device 17 and also provide a layer of protection. First panel 12 has slidable display device 18 extended out of it to add an external display to electronic device 17. Guide rail 26 attached to the back of slidable display device 18 guides the extension of slidable display device 18 out of first panel 12.

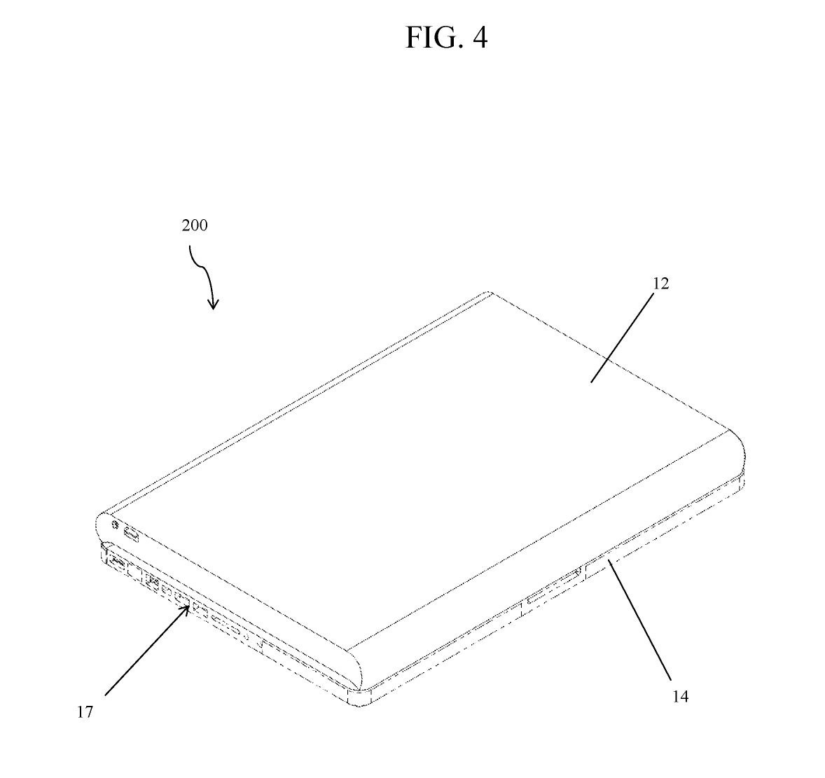

FIG. 4 depicts electronic device 17 in a closed position while engaged by apparatus 200. First panel 12 provides a layer of protection on top of electronic device 17. Second panel 14 provides protection under the base of electronic device 17.

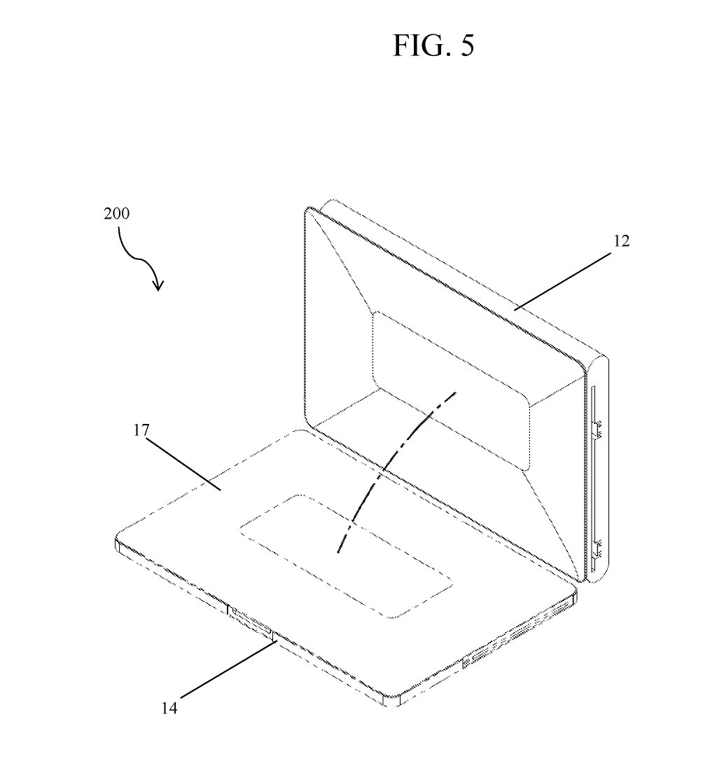

FIG. 5 depicts apparatus 200 engaged to electronic device 17 while electronic device is being closed and opened. First panel 12 is able to follow the movement of electronic device 17 into the closed position depicted in FIG. 4.

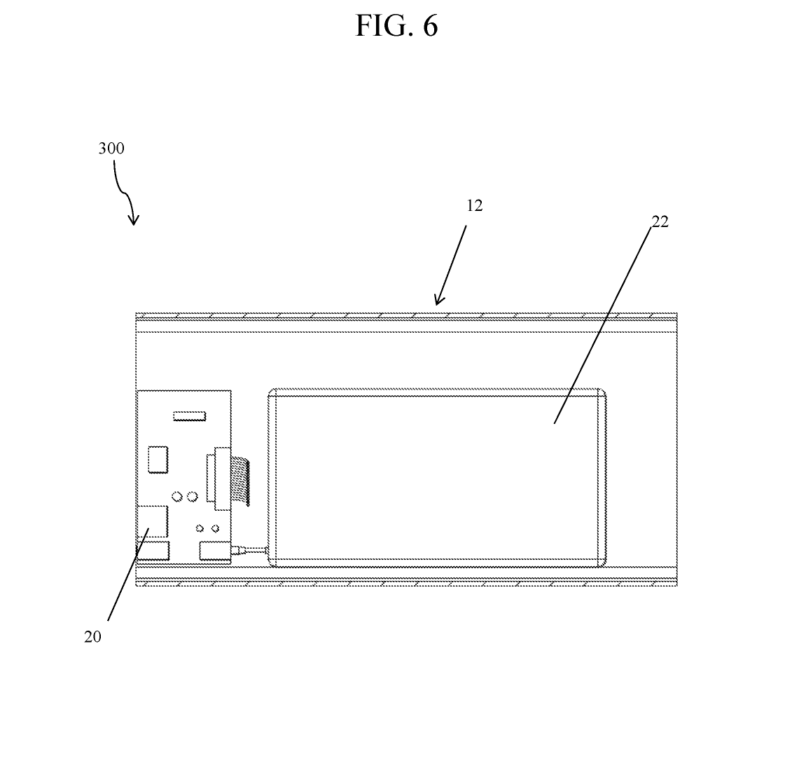

FIG. 6 depicts an internal view 300 of first panel 12. Power supply 22 will provide power to the apparatus. Display manager 20 will enable the engaged electronic device to control the slidable display device.

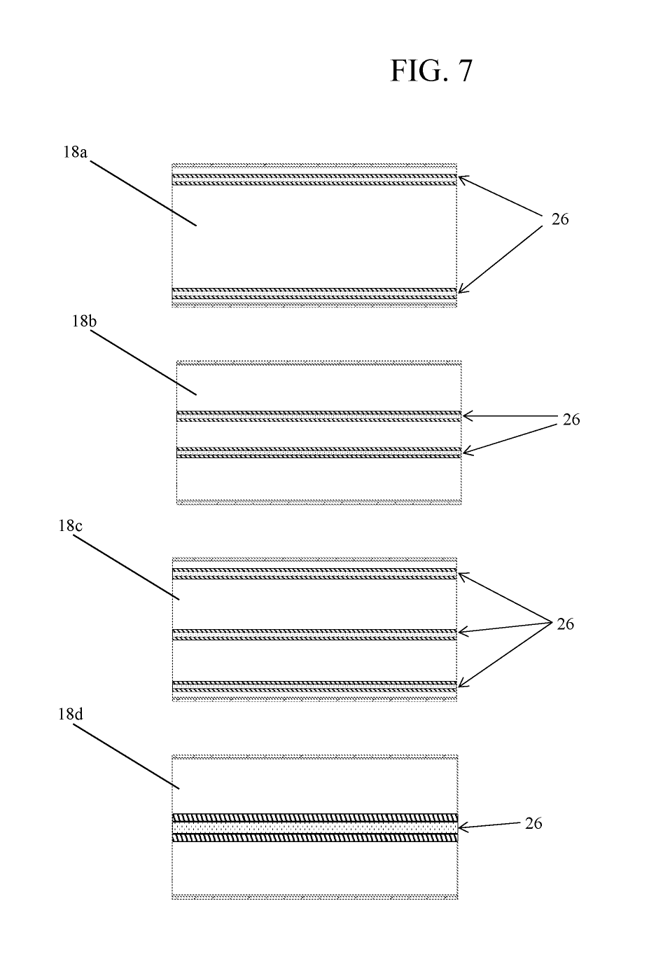

FIG. 7 illustrates examples of different embodiments of the placements of guide rail 26 on the back of slidable display device 18 used to guide the sliding of slidable display device 18 out of the apparatus. The placements of the railings 26 can vary in regards to its location on the back of slidable display device 18. Slidable display device 18a shows the railings 26 placed along the edges of the slidable display device 18a. On slidable display device 18b, the railings 26 are closely justified to around the center of slidable display device 18b. In addition to variations of placements of the railings 26, slidable display device 18c and 18d show that there can be different embodiments in regards to the number of railings. Slidable display device 18c illustrates an embodiment with more than two railings 26. Slidable display device 18d shows an embodiment with only a single railing 26. The number of railings attached to the back of the slidable display device can be 0, 1, 2, 3, 4, 5, or more. The placement of the railings can be anywhere on the back from the edge as in slidable display device 18a to being justified around or along the middle as in slidable display device 18b and 18d.

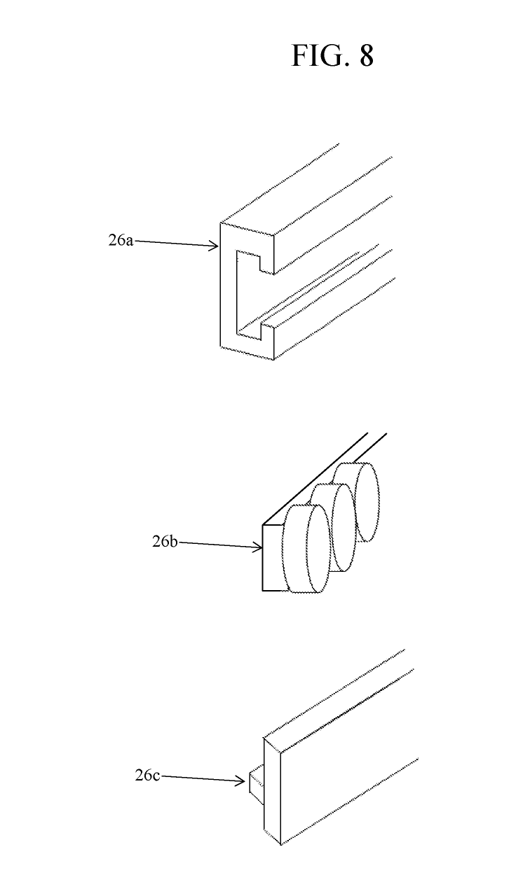

FIG. 8 illustrates different embodiments of guide guide rail 26 that can be attached to the back of slidable display 18 to guide the positioning of slidable display device 18 out of first panel 12. Guide rail 26a and 26c are examples of guide rail designs that will slide into a complementary guide rail cutouts 28 in first panel 12 to guide the positioning of the slidable display device 18.

Guide rail 26b illustrates an example of a guide wheel rail assembly. Railing 26b has rolling element bearings that can roll on rails with complementary profile surfaces.

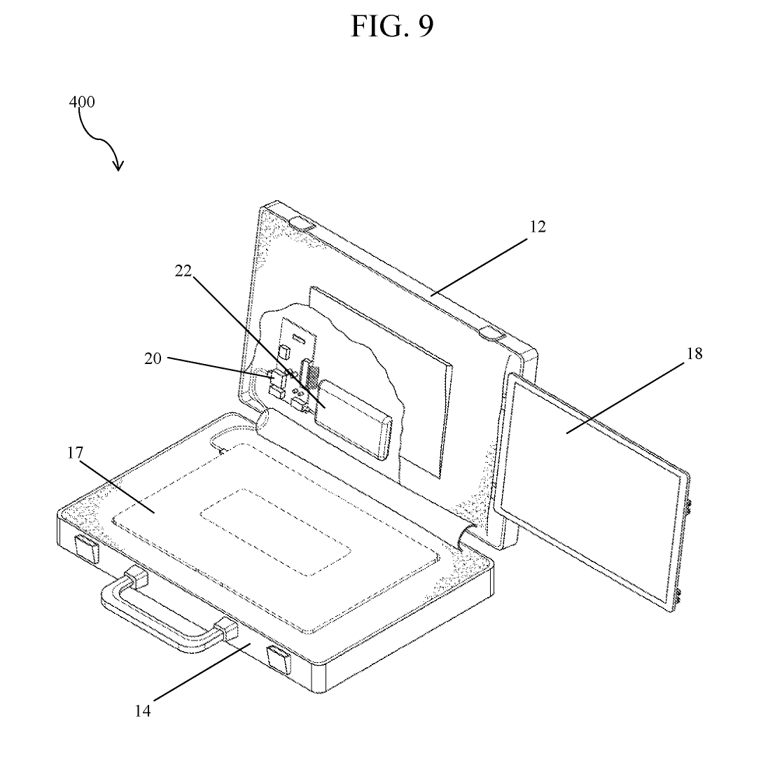

FIG. 9 depicts apparatus 400 which is an embodiment as an electronic device case. Apparatus 400 is a case that has a first panel 12 and second panel 14 configured together to hold an electronic device 17. First panel 12 has a slidable display device 18 that extends out to add an external display to electronic device 17. Apparatus 400 also has a power supply 22 that powers slidable display device 18. FIG. 9 also illustrates apparatus 400 with a wired embodiment of device manager 20 connecting electronic device 18 to apparatus 400. Display manager 20 enables electronic device 17 to control slidable display device 18.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 6,859,219

U.S. Pat. No. 6,532,146

U.S. Pat. No. 7,136,282

U.S. Patent Application Publication No. 2003/0218577

U.S. Patent Application Publication No. 2004/0264126

U.S. Patent Application Publication No. 2005/0137942

U.S. Patent Application Publication No. 2006/0247798

U.S. Patent Application Publication No. 2006/0082518

U.S. Patent Application Publication No. 2009/0201222

U.S. Patent Application Publication No. 2011/0298690

U.S. Patent Application Publication No. 2011/0247249

U.S. Patent Application Publication No. 2013/0021734

U.S. Patent Application Publication No. 2013/0311889

What is claimed is:

1. An apparatus comprising:
a first panel configured to releasably engage an electronic device wherein the first panel further comprises a slidable display device;
a display manager adapted to enable the electronic device to control the slidable display device; and
a power supply to power the slidable display device.

2. The apparatus of claim 1, wherein the electronic device has a first surface and a second surface, and the apparatus further comprises a second panel, wherein the second panel is configured to releasably engage the second surface of the electronic device.

3. The apparatus of claim 2, wherein the first panel is connected to the second panel.

4. The apparatus of claim 1, wherein the first panel further comprises a first side, a second side, a third side, and a fourth side, wherein the slidable display device slides out of at least one of the first side, second side, third side, or fourth side of the first panel.

5. The apparatus of claim 1, wherein the first panel further comprises additional slidable display devices.

6. The apparatus of claim 5, wherein the first panel further comprises a first side, a second side, a third side, and a fourth side, wherein the at least two of the slidable display devices slide out of at least one of the first side, second side, third side, or fourth side of the first panel.

7. The apparatus of claim 5, wherein each additional slidable display device further comprises one or more additional video cards.

8. The apparatus of claim 1, wherein the electronic device is further defined as comprising an electronic device display, and the display manager is adapted to enable the electronic device to control the slidable display device independently of the activity or inactivity of the electronic device display.

9. The apparatus of claim 1, wherein the first panel further comprises at least one hinge between the first panel and the slidable display device to enable the rotation of the slidable display device when extended.

10. The apparatus of claim 1, wherein the positioning of the slidable display device is motorized.

11. The apparatus of claim 1, wherein the first panel fully encloses the slidable display device when not extended.

12. The apparatus of claim 1, wherein the display manager wirelessly connects the electronic device to the slidable display device.

13. The apparatus of claim 1, wherein the display manager is integral with at least one of the first panel, a second panel, or the electronic device, or independent from the first panel, the second panel, and the electronic device.

14. The apparatus of claim 1, wherein the power supply is integral with the first panel, a second panel, or the electronic device, or independent from the first panel, the second panel, and the electronic device.

15. A case with a sliding display comprising:
a first panel configured with a second panel to hold an electronic device wherein the first panel further comprises a slidable display device;
a display manager adapted to enable the electronic device to control the slidable display device; and
a power supply to power the slidable display device.

16. The case of claim 15, wherein the first panel and the second panel are connected with a hinge.

17. The case of claim 15, wherein the first panel and the second panel are directly connected.

18. The case of claim 15, wherein the first panel further comprises a first side, a second side, a third side, and a fourth side, wherein the slidable display device slides out of at least one of the first side, second side, third side, or fourth side of the first panel.

19. The case of claim 15, wherein the first panel further comprises additional slidable display devices.

20. The case of claim 16, wherein the first panel further comprises a first side, a second side, a third side, and a fourth side, wherein the at least two of the slidable display devices slide out of at least one of the first side, second side, third side, or fourth side of the first panel.

21. The case of claim 16, wherein each additional slidable display device further comprises one or more additional video cards.

22. The case of claim 15, wherein the electronic device is further defined as comprising an electronic device display, and the display manager is adapted to enable the electronic device to control the slidable display device independently of the activity or inactivity of the electronic device display.

23. The case of claim 15, wherein the first panel further comprises at least one hinge between the first panel and the slidable display device to enable the rotation of the slidable display device when extended.

24. The case of claim 15, wherein the positioning of the slidable display device is motorized.

25. The case of claim 15, wherein the first panel fully encloses the slidable display device when not extended.

26. The case of claim 15, wherein the display manager wirelessly connects the electronic device to the slidable display device.

27. The case of claim 15, wherein the display manager is integral with at least one of the first panel, a second panel, or the electronic device, or independent from the first panel, the second panel, and the electronic device.

28. The case of claim 15, wherein the power supply is integral with the first panel, a second panel, or the electronic device, or independent from the first panel, the second panel, and the electronic device.

29. A method for adding an external display to an electronic device comprising:
engaging an electronic device to an apparatus comprising:
a first panel configured to releasably engage the electronic device wherein the first panel further comprises a slidable display device;
a display manager adapted to enable control over the slidable display device using the engaged electronic device; and
a power supply to power the slidable display device;
positioning the slidable display device to a desired position; and
initiating the display manager to connect the slidable display device to the engaged electronic device.

30. The method of claim 29, wherein the electronic device has a first surface and a second surface, wherein the slidable display apparatus further comprises a second panel configured to releasably engage the second surface of the electronic device, and the engaging of the electronic device to the slidable display apparatus further comprises engaging the first panel of the slidable display apparatus to the first surface of the electronic device, and engaging the second panel of the slidable display apparatus to the second surface of the electronic device.

31. The method of claim 29, wherein the first panel further comprises a first side, a second side, a third side, and a fourth side, and the positioning of the slidable display device further comprises sliding the slidable display device from at least one of the first side, second side, third side, or fourth side of the first panel.

32. The method of claim 29, wherein the first panel further comprises additional slidable display devices, and the positioning of the slidable display device further comprises positioning at least two slidable display devices to a desired position.

33. The method of claim 32, wherein the first panel further comprises a first side, a second side, a third side, and a fourth side, and the positioning of at least two slidable display devices further comprising sliding of at least two of the slidable display devices from at least one of the first side, second side, third side, or fourth side of the first panel.

34. The method of claim 29, wherein the electronic device is further defined as comprising an electronic device display, and the initiating of the display manager further comprises connecting the slidable display device to the engaged electronic device independent of the activity or inactivity of the electronic device display.

35. The method of claim 29, wherein positioning of the slidable display device is motorized.

36. The method of claim 29, wherein initiating the display manager further comprises connecting the slidable display device wirelessly to the electronic device.

37. The method of claim 29, wherein the display manager is integral with at least one of the first panel, a second panel, or the electronic device, or independent from the first panel, the second panel, and the electronic device.

38. A method of making an apparatus that adds an external display to an electronic device comprising:
obtaining a first panel configured to releasably engage an electronic device; attaching a slidable display device to the first panel;
integrating a display manager with the apparatus to enable the electronic device to control the slidable display device; and
integrating a power supply with the apparatus to power the slidable display device.

39. The method of claim 38, wherein the electronic device has a first surface and a second surface, the method further comprises obtaining a second panel configured to releasably engage the second surface of the electronic device.

40. The method of claim 39, further comprising connecting the first panel and the second panel.

41. The method of claim 38, further comprising attaching additional slidable display devices to the first panel.

42. The method of claim 41, further comprising connecting one or more video cards to each additional slidable display device.

43. The method of claim 38, wherein the integration of the display manager further comprises connecting the display manager to at least one of the first panel, a second panel, or the electronic device, or being independent from the first panel, the second panel, and the electronic device.

44. The method of claim 38, wherein the integration of the power supply further comprises connecting the power supply to at least one of the first panel, a second panel, or the electronic device, or being independent from the first panel, the second panel, and the electronic device.
